(19) United States
(12) Patent Application Publication
(10) Pub. No.: US 2024/0217878 A1
(43) Pub. Date: Jul. 4, 2024

(54) CERAMIC MATERIAL AND METHOD OF FORMING THE SAME

(71) Applicant: INDUSTRIAL TECHNOLOGY RESEARCH INSTITUTE, Hsinchu (TW)

(72) Inventors: Tien-Heng HUANG, Tainan City (TW); Yu-Han WU, Taipei City (TW); Kuo-Chuang CHIU, Hsinchu City (TW)

(73) Assignee: INDUSTRIAL TECHNOLOGY RESEARCH INSTITUTE, Hsinchu (TW)

(21) Appl. No.: 18/170,367

(22) Filed: Feb. 16, 2023

(30) Foreign Application Priority Data
Jan. 4, 2023 (TW) 112100167

(51) Int. Cl. C04B 35/18; C04B 35/64

(52) U.S. Cl. CPC C04B 35/18; C04B 35/64; C04B 2235/3298; C04B 2235/3409; C04B 2235/3463; C04B 2235/723; C04B 2235/728

(57) ABSTRACT

A method of forming a ceramic material includes providing a mixture of solid powder, which includes precursors of crystalline aluminum silicate, amorphous fluxing agent, and amorphous modifier. The method also sinters the mixture of solid powder at 1600° C. to 1800° C. to form the ceramic material, which includes 100 parts by weight of the crystalline aluminum silicate having a chemical formula of AlSiₓO_{1.5+2x}, wherein x is 0.21 to 0.35, 10 to 15 parts by weight of the amorphous fluxing agent, and 5 to 10 parts by weight of the amorphous modifier.

### CROSS REFERENCE TO RELATED APPLICATIONS

The present application is based on, and claims priority from, Taiwan Application Serial Number 112100167, filed on Jan. 4, 2023, the disclosure of which is hereby incorporated by reference herein in its entirety.

### TECHNICAL FIELD

The technical field relates to a ceramic material and a method for manufacturing the same.

### BACKGROUND

The rise in demand for 5G mobile broadband communications in ICT/IoT, wearable electronics, and green energy applications has accelerated the growth of domestic high-frequency industry-related markets, such as millimeter wave substrates, materials/components, and module integration. Moreover, in order to achieve full 5G applications (4G or 5G sub-6 GHz and 5G mmWave), low temperature co-fired ceramic (LTCC) components and packaging powders should be developed with a low temperature sintering, a low dielectric constant, a low dielectric loss, and a low temperature coefficient of resonant frequency. This way, a highly reliable, miniaturized LTCC packaging technology with high-integration capability, low water absorption, and high heat dissipation can be achieved that is compatible with millimeter-wave high frequency and low loss requirements.

### SUMMARY

One embodiment of the disclosure provides a ceramic material, including 100 parts by weight of a crystalline aluminum silicate having a chemical formula of AlSiₓO_{1.5+2x}, wherein x is 0.21 to 0.35; 10 to 15 parts by weight of an amorphous fluxing agent; and 5 to 10 parts by weight of an amorphous modifier.

One embodiment of the disclosure provides a method of forming a ceramic material, which includes providing a mixture of solid powder, which includes precursors of a crystalline aluminum silicate, an amorphous fluxing agent, and an amorphous modifier; and sintering the mixture of solid powder at 1600° C. to 1800° C. to form the ceramic material, which includes 100 parts by weight of the crystalline aluminum silicate having a chemical formula of AlSiₓO_{1.5+2x}, wherein x is 0.21 to 0.35; 10 to 15 parts by weight of the amorphous fluxingagent; and 5 to 10 parts by weight of the amorphous modifier.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows an XRD spectrum of a ceramic material in one embodiment of the disclosure.

FIG. 2 shows an XRD spectrum of a ceramic material in one embodiment of the disclosure.

FIG. 3 shows an XRD spectrum of a ceramic material in one embodiment of the disclosure.

FIG. 4 shows an XRD spectrum of a ceramic material in one embodiment of the disclosure.

FIG. 5 shows an XRD spectrum of a ceramic material in one embodiment of the disclosure.

FIG. 6 shows an XRD spectrum of a ceramic material in one embodiment of the disclosure.

FIG. 7 shows an XRD spectrum of a ceramic material in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a method of forming a ceramic material, which includes providing a mixture of solid powder, which includes precursors of a crystalline aluminum silicate, an amorphous fluxing agent, and an amorphous modifier. For example, a glass powder containing aluminum oxide, silicon oxide, and calcium oxide (serving as the precursor of the crystalline aluminum silicate and the precursor of the amorphous modifier), an aluminum oxide powder (serving as the precursor of the crystalline aluminum silicate), and a boric acid powder (serving as the precursor of the amorphous fluxing agent) can be mixed to form a mixture. In addition, the aluminum oxide powder (serving as the precursor of the crystalline aluminum silicate), the silicon oxide powder (serving as the precursor of the crystalline aluminum silicate), a calcium hydroxide powder (serving as the precursor of the amorphous modifier), and the boric acid powder (serving as the precursor of the amorphous fluxing agent) can be mixed to form the mixture. Alternatively, solid powder of other precursors of the crystalline aluminum silicate, the amorphous fluxing agent, and the amorphous modifier can be mixed to form the mixture.

The mixture of solid powder is then sintered at 1600° ° C. to 1800° C. to form the ceramic material. The ceramic material includes 100 parts by weight of the crystalline aluminum silicate having a chemical formula of AlSiₓO_{1.5+2x}, wherein x is 0.21 to 0.35; 10 to 15 parts by weight of the amorphous fluxing agent; and 5 to 10 parts by weight of the amorphous modifier. In some embodiments, the x can be 0.28 to 0.35. If x is too low (i.e. the amount of silicon oxide is too low or the amount of aluminum oxide is too high), the aluminum oxide phase will dominate, and causes higher dielectric constant (Dk) value of the ceramic material. If x is too high (i.e. the amount of silicon oxide is too high or the amount of aluminum oxide is too low), a large amount of silicon oxide phase will precipitate out which lower the crystallinity of the ceramic material, such that the Dk and dielectric loss (Df) values of the ceramic material will be increased. If the amount of amorphous fluxing agent is too low, the phase formation temperature will be increased and the ceramic material cannot be easily crystallized. If the amount of amorphous fluxing agent is too high, the phase formation temperature will be decreased, and the melting-state of the ceramic material will be easily formed. As such, the ceramic material will be not easily crystallized. If the amount of amorphous modifier is too low, the crystallinity of the ceramic material will also be lowered. If the amount of amorphous modifier is too high, an impurity phase will be easily formed in the ceramic material.

In some embodiments, the amorphous fluxing agent includes boron oxide, bismuth oxide, or a combination thereof. In one embodiment, the amorphous fluxing agent is boron oxide. In some embodiments, the amorphous modifier includes calcium oxide, titanium oxide, copper oxide, potassium oxide, or a combination thereof. In one embodiment, the amorphous modifier is calcium oxide.

In some embodiments, the crystalline aluminum silicate has a chemical formula of AlSi_{0.35}O_{2.20}. In some embodiments, the crystalline aluminum silicate has a chemical formula of AlSi_{0.29}O_{2.08}. In some embodiments, the crystalline aluminum silicate has a chemical formula of AlSi_{0.21}O_{1.92}. In some embodiments, the crystalline aluminum silicate has a chemical formula of AlSi_{0.28}O_{2.06}. In some embodiments, the ceramic material has a dielectric constant of 3.7 to 14.1 (at 1 GHz). For example, the ceramic material has a dielectric constant of 3.7 to 6.9 (at 1 GHz). In some embodiments, the ceramic material has a dielectric loss of 5×10⁻⁴ to 3.1×10⁻² (at 1 GHz). For example, the ceramic material has a dielectric loss of 5×10⁻⁴ to 3.1×10⁻³ (at 1 GHz). In some embodiments, the ceramic material has a coefficient of thermal expansion of 5.9×10⁻⁶/° C. to 6.0×10⁻⁶/° C. at 300° C.

Subsequently, an appropriate amount of ceramic material powder can be pressed and kept at 800° C. to 900° C. for a period of time to be molded as a ceramic object. Note that the molding temperature for molding the ceramic material powder to form the ceramic object is greatly lower than the formation temperature of the ceramic material powder, such that the ceramic material powder from crushing the ceramic object can be pressed again to mold another ceramic object. In other words, the ceramic material powder has a recyclable property.

The method of forming the ceramic material is correlated with solid-state sintering with no sol-gel process needed, which is simple and proper for mass production.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

18.6 g of glass powder A (containing 10.69 wt % of aluminum oxide, 50.65 parts by weight of silicon oxide, 10.58 wt % of calcium oxide, and 20.77 wt % of boron oxide), 11.4 g of aluminum oxide, and 3 g of boric acid were added to ethanol to be ground and dispersed, and then after baking, the dried mixture was heated to 1650° C. and sintered for 2 hours, and then cooled to obtain a ceramic material powder. The ceramic material powder was analyzed by XRD, and the spectrum showed the signals of the crystalline aluminum silicate (Al_{2.22}Si_{0.78}O_{4.89}, i.e. AlSi_{0.35}O_{2.20}) and that of the crystalline silicon oxide (SiO₂), as shown in FIG. 1. According to the element analysis result, the ceramic material powder included 49.78 parts by weight of Al₂O₃, 34.2 parts by weight of SiO₂, 11.39 parts by weight of B₂O₃, and 6.43 parts by weight of CaO. Al₂O₃ and SiO₂ constituted the crystalline aluminum silicate and a small amount of the crystalline silicon oxide. Since B₂O₃ and CaO were amorphous materials, no signal was observed in the XRD spectrum.

An appropriate amount of ceramic material was pressed at a pressure of 40 kg/m² to form a round billet with a diameter of 11 mm, which was kept at 850° C. for 2 hours to mold the ceramic material powder. The obtained product had a dielectric constant Dk of 5.5558 (at 1 GHZ), a dielectric loss Df of 5×10⁻⁴ (at 1 GHZ), and a coefficient of thermal expansion of 5.91×10⁻⁶/° C. at 300° C. The dielectric constant and the dielectric loss were measured according to the standard IPC-TM-650, and the coefficient of thermal expansion was measured according to the standard ASTM E288-11.

### Example 2

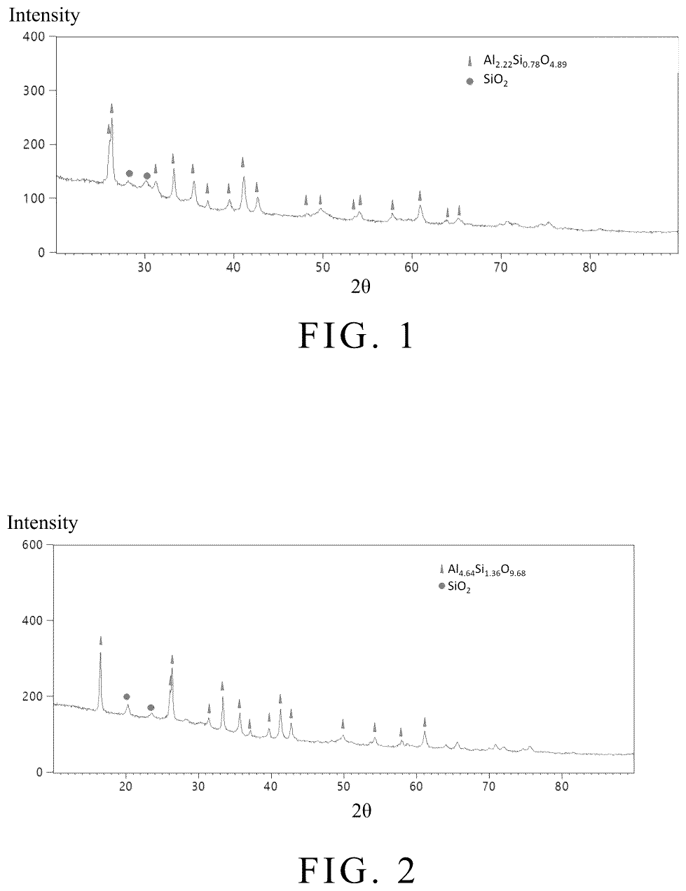

13.12 g of aluminum oxide, 5.43 g of silicon oxide, 2.24 g of calcium hydroxide, and 10.06 g of boric acid were added to ethanol to be ground and dispersed, and then after baking, the dried mixture was heated to 1650° C. and sintered for 2 hours, and then cooled to obtain a ceramic material powder. The ceramic material powder was analyzed by XRD, and the spectrum showed the signals of the crystalline aluminum silicate (Al_{4.64}Si_{1.36}O_{9.68}, i.e. AlSi_{0.29}O_{2.08}) and that of the crystalline silicon oxide (SiO₂), as shown in FIG. 2. According to the element analysis result, the ceramic material powder included 60.06 parts by weight of Al₂O₃, 22.85 parts by weight of SiO₂, 9.78 parts by weight of B₂O₃, and 7.31 parts by weight of CaO. Al₂O₃ and SiO₂ constituted the crystalline aluminum silicate and a small amount of the crystalline silicon oxide. Since B₂O₃ and CaO were amorphous materials, no signal was observed in the XRD spectrum.

An appropriate amount of ceramic material was pressed at a pressure of 40 kg/m² to form a round billet with a diameter of 11 mm, which was kept at 850° C. for 2 hours to mold the ceramic material powder. The obtained product had a dielectric constant Dk of 3.7996 (at 1 GHz), a dielectric loss Df of 1.6×10⁻³ (at 1 GHz). The dielectric constant and the dielectric loss were measured according to the standard IPC-TM-650.

### Example 3

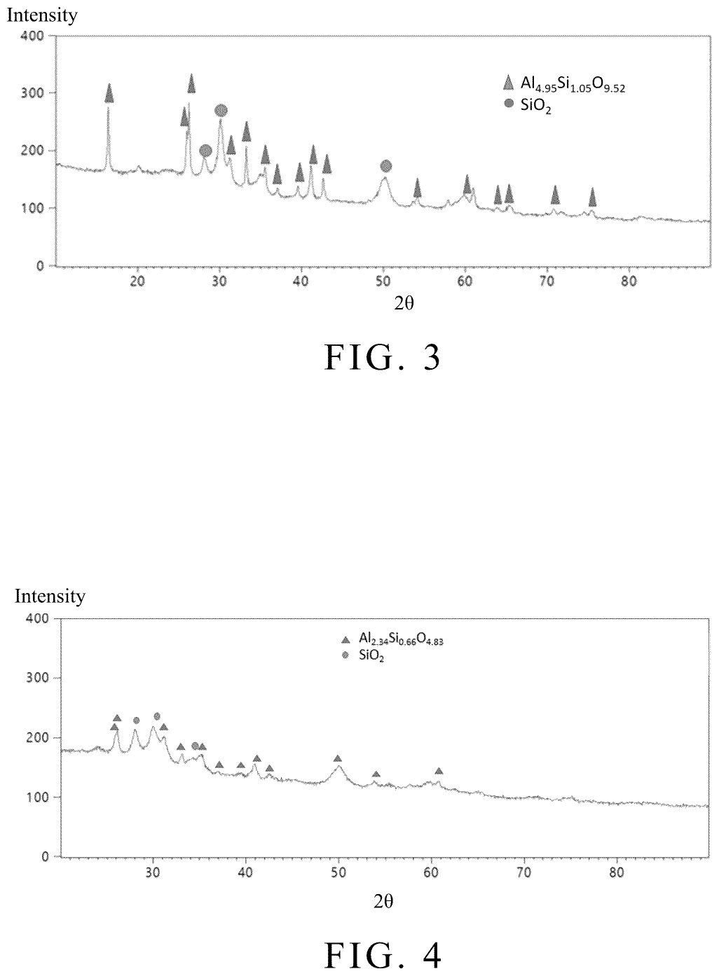

20.392 g of aluminum oxide, 10.192 g of silicon oxide, 3.9305 g of calcium carbonate, and 15.407 g of boric acid were added to ethanol to be ground and dispersed, and then after baking, the dried mixture was heated to 1650° C. and sintered for 2 hours, and then cooled to obtain a ceramic material powder. The ceramic material powder was analyzed by XRD, and the spectrum showed the signals of the crystalline aluminum silicate (Al_{4.95}Si_{1.05}O_{9.52}, i.e. AlSi_{0.21}O_{1.92}) and that of the crystalline silicon oxide (SiO₂), as shown in FIG. 3. According to the element analysis result, the ceramic material powder included 56.74 parts by weight of Al₂O₃, 25.37 parts by weight of SiO₂, 12.03 parts by weight of B₂O₃, and 5.86 parts by weight of CaO. Al₂O₃ and SiO₂ constituted the crystalline aluminum silicate and a small amount of the crystalline silicon oxide. Since B₂O₃ and CaO were amorphous materials, no signal was observed in the XRD spectrum.

An appropriate amount of ceramic material was pressed at a pressure of 40 kg/m² to form a round billet with a diameter of 11 mm, which was kept at 850° C. for 2 hours to mold the ceramic material powder. The obtained product had a dielectric constant Dk of 14.054 (at 1 GHz), a dielectric loss Df of 3.03×10⁻² (at 1 GHz). The dielectric constant and the dielectric loss were measured according to the standard IPC-TM-650.

### Example 4

39.8 g of aluminum oxide, 24.6 g of silicon oxide, 5.1 g of calcium hydroxide, and 30.5 g of boric acid were added to ethanol to be ground and dispersed, and then after baking, the dried mixture was heated to 1650° C. and sintered for 2 hours, and then cooled to obtain a ceramic material powder. The ceramic material powder was analyzed by XRD, and the spectrum showed the signals of the crystalline aluminum silicate (Al_{2.34}Si_{0.66}O_{4.83}, i.e. AlSi_{0.28}O_{2.06}) and that of the crystalline silicon oxide (SiO₂), as shown in FIG. 4. According to the element analysis result, the ceramic material powder included 52.16 parts by weight of Al₂O₃, 32.15 parts by weight of SiO₂, 11.84 parts by weight of B₂O₃, and 4.85 parts by weight of CaO. Al₂O₃ and SiO₂ constituted the crystalline aluminum silicate and a small amount of the crystalline silicon oxide. Since B₂O₃ and CaO were amorphous materials, no signal was observed in the XRD spectrum.

An appropriate amount of ceramic material was pressed at a pressure of 40 kg/m² to form a round billet with a diameter of 11 mm, which was kept at 850° C. for 2 hours to mold the ceramic material powder. The obtained product had a dielectric constant Dk of 6.801 (at 1 GHz), a dielectric loss Df of 3.1×10⁻³ (1 at GHz). The dielectric constant and the dielectric loss were measured according to the standard IPC-TM-650.

### Comparative Example 1

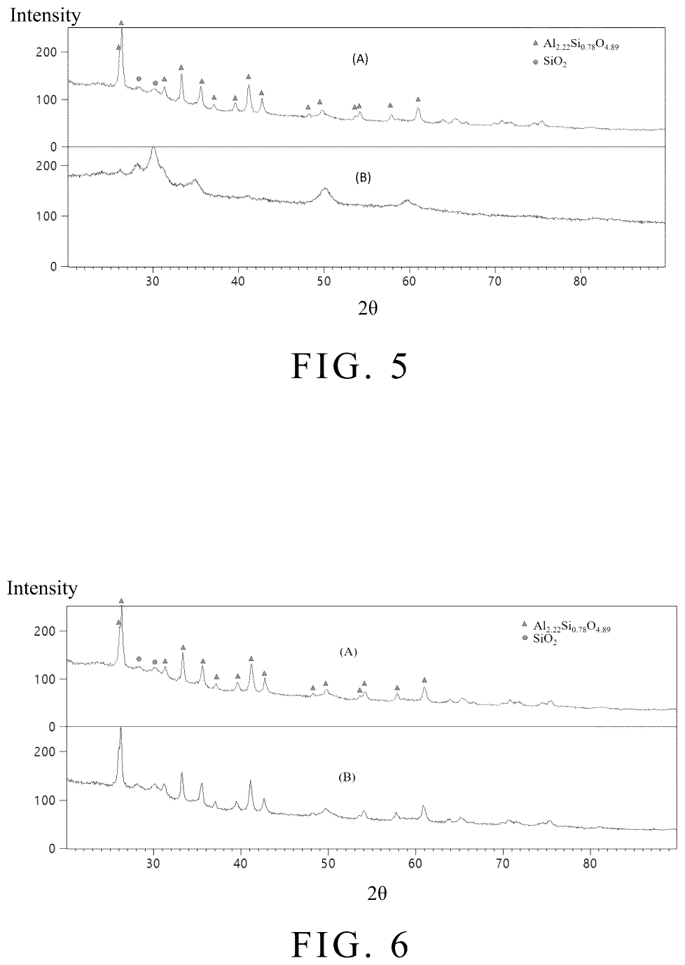

18.6 g of glass powder A (containing 10.69 wt % of aluminum oxide, 50.65 parts by weight of silicon oxide, 10.58 wt % of calcium oxide, and 20.77 wt % of boron oxide) and 5.4 g of aluminum oxide were added to ethanol to be ground and dispersed, and then after baking, the dried mixture was heated to 1650° C. and sintered for 2 hours, and then cooled to obtain a ceramic material powder. The ceramic material powder was analyzed by XRD. Compared to the XRD spectrum in Example 1 (e.g. part (A) in FIG. 5), the XRD spectrum (e.g. part (B) in FIG. 5) in Comparative Example 1 showed that the ceramic material powder deviated from the target crystalline phase of the aluminum silicate (Al_{2.22}Si_{0.78}O_{4.89}, i.e. AlSi_{0.35}O_{2.20}). The XRD spectrum (e.g. part (B) in FIG. 5) in Comparative Example 1 showed the signals of weak crystalline silicon oxide (SiO₂).

An appropriate amount of ceramic material was pressed at a pressure of 40 kg/m² to form a round billet with a diameter of 11 mm, which was kept at 850° C. for 2 hours to mold the ceramic material powder. The above-mentioned product had a dielectric constant Dk of 7.3342 (at 1 GHz) and a dielectric loss Df of 2.4×10⁻³ (at 1 GHz), which were higher than the dielectric constant Dk of 5.5558 (1 GHZ) and the dielectric loss Df of 5×10⁻⁴ (1 GHz) in Example 1. The dielectric constant and the dielectric loss were measured according to the standard IPC-TM-650.

### Comparative Example 2

18.6 g of glass powder A (containing 10.69 wt % of aluminum oxide, 50.65 parts by weight of silicon oxide, 10.58 wt % of calcium oxide, and 20.77 wt % of boron oxide) and 11.4 g of aluminum oxide were added to ethanol to be ground and dispersed, and then after baking, the dried mixture was heated to 1650° C. and sintered for 2 hours, and then cooled to obtain a ceramic material powder. The ceramic material powder was analyzed by XRD. Compared to the XRD spectrum in Example 1 (e.g. part (A) in FIG. 6), the XRD spectrum (e.g. part (B) in FIG. 6) in Comparative Example 2 showed that the ceramic material powder formed without adding boric acid would form the crystalline aluminum silicate (Al_{2.22}Si_{0.78}O_{4.89}, i.e. AlSi_{0.35}O_{2.20}) with a stronger impurity phase signal of the crystalline silicon oxide (SiO₂).

An appropriate amount of ceramic material was pressed at a pressure of 40 kg/m² to form a round billet with a diameter of 11 mm, which was kept at 850° C. for 2 hours to mold the ceramic material powder. The above-mentioned product had a dielectric constant Dk of 6.1172 (at 1 GHZ) and a dielectric loss Df of 9×10⁻⁴ (at 1 GHz), which were higher than the dielectric constant Dk of 5.5558 (at 1 GHz) and the dielectric loss Df of 5×10⁻⁴ (at 1 GHz) in Example 1. The dielectric constant and the dielectric loss were measured according to the standard IPC-TM-650.

### Example 5

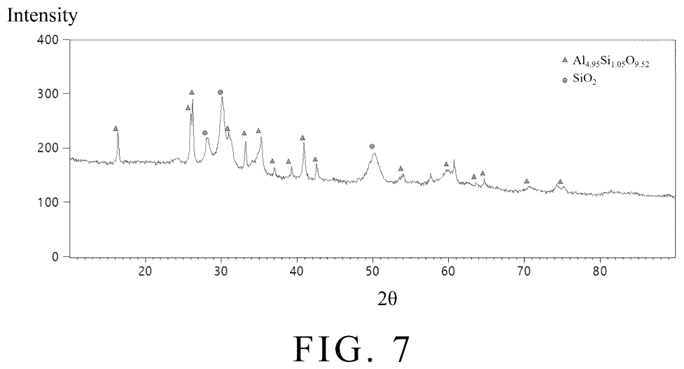

20.392 g of aluminum oxide, 10.196 g of silicon oxide, 0.9098 g of calcium carbonate, and 4.5314 g of boric acid were added to ethanol to be ground and dispersed, and then after baking, the dried mixture was heated to 1650° C. and sintered for 2 hours, and then cooled to obtain a ceramic material powder. The ceramic material powder was analyzed by XRD, and the spectrum showed the signals of the crystalline aluminum silicate (Al_{4.95}Si_{1.05}O_{9.52}, i.e. AlSi_{0.21}O_{1.92}) and that of the crystalline silicon oxide (SiO₂), as shown in FIG. 7.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A ceramic material, comprising:
100 parts by weight of a crystalline aluminum silicate having a chemical formula of AlSiₓO_{1.5+2x}, wherein x is 0.21 to 0.35;
10 to 15 parts by weight of an amorphous fluxing agent; and
5 to 10 parts by weight of an amorphous modifier.

2. The ceramic material as claimed in claim 1, wherein the amorphous fluxing agent comprises boron oxide, bismuth oxide, or a combination thereof.

3. The ceramic material as claimed in claim 1, wherein the amorphous modifier comprises calcium oxide, titanium oxide, copper oxide, potassium oxide, or a combination thereof.

4. The ceramic material as claimed in claim 1, wherein the crystalline aluminum silicate has a chemical formula of AlSi_{0.35}O_{2.20}.

5. The ceramic material as claimed in claim 1, wherein the crystalline aluminum silicate has a chemical formula of AlSi_{0.29}O_{2.08}.

6. The ceramic material as claimed in claim 1, wherein the crystalline aluminum silicate has a chemical formula of AlSi_{0.21}O_{1.92}.

7. The ceramic material as claimed in claim 1, wherein the crystalline aluminum silicate has a chemical formula of AlSi_{0.28}O_{2.06}.

8. The ceramic material as claimed in claim 1, wherein the ceramic material has a dielectric constant of 3.7 to 14.1 (at 1 GHz).

9. The ceramic material as claimed in claim 1, wherein the ceramic material has a dielectric loss of 5×10⁻⁴ to 3.1×10⁻² (at 1 GHz).

10. The ceramic material as claimed in claim 1, wherein the ceramic material has a coefficient of thermal expansion of 5.9×10⁻⁶/° C. to 6.0×10⁻⁶/° C. at 300° C.

11. A method of forming a ceramic material, comprising:
providing a mixture of solid powder, which includes precursors of a crystalline aluminum silicate, an amorphous fluxing agent, and an amorphous modifier; and
sintering the mixture of solid powder at 1600° C. to 1800° ° C. to form the ceramic material, which includes
100 parts by weight of the crystalline aluminum silicate having a chemical formula of AlSiₓO_{1.5+2x}, wherein x is 0.21 to 0.35;
10 to 15 parts by weight of the amorphous fluxing agent; and
5 to 10 parts by weight of the amorphous modifier.

12. The method as claimed in claim 11, wherein the amorphous fluxing agent comprises boron oxide, bismuth oxide, or a combination thereof.

13. The method as claimed in claim 11, wherein the amorphous modifier comprises calcium oxide, titanium oxide, copper oxide, potassium oxide, or a combination thereof.

14. The method as claimed in claim 11, wherein the crystalline aluminum silicate has a chemical formula of AlSi_{0.35}O_{2.20}.

15. The method as claimed in claim 11, wherein the crystalline aluminum silicate has a chemical formula of AlSi_{0.29}O_{2.08}.

16. The method as claimed in claim 11, wherein the crystalline aluminum silicate has a chemical formula of AlSi_{0.21}O_{1.92}.

17. The method as claimed in claim 11, wherein the crystalline aluminum silicate has a chemical formula of AlSi_{0.28}O_{2.06}.
